(19) United States
(12) Patent Application Publication
(10) Pub. No.: US 2022/0245866 A1
(43) Pub. Date: Aug. 4, 2022

(54) DEVICE AND METHOD FOR AUTOMATICALLY COLORING CARTOON SKETCH IMAGE

(71) Applicant: icode-lab corps., Seoul (KR)

(72) Inventors: Hyun SEO, Seoul (KR); Seungwon JEONG, Seoul (KR)

(73) Assignee: icode-lab corps., Seoul (KR)

(21) Appl. No.: 17/587,834

(22) Filed: Jan. 28, 2022

(30) Foreign Application Priority Data
Jan. 29, 2021 (KR) 10-2021-0013380

(51) Int. Cl. G06T 11/00; G06V 10/74; G06T 7/11

(52) U.S. Cl. CPC G06T 11/001; G06T 7/11; G06V 10/761

(57) ABSTRACT

A device is disclosed. The device includes: a communicating circuit configured to receive a sketch image of a cartoon from a user terminal, a memory configured to store the sketch image and painted images, and a processor configured to, by executing a program stored in the memory, determine a reference painted image to be referred for painting the sketch image among the stored painted images, in which the processor determines the reference painted image based on similarity between the painted image and each of the painted images.

### TECHNICAL FIELD

The present disclosure relates to a device and a method for automatically coloring a sketch image of a cartoon.

### BACKGROUND ART

In general, a cartoon means a picture with a story (meaning) or an expression form that expresses a single big story by arranging the pictures. In the past, the writer completed the cartoon by drawing and coloring a cartoon sketch by hand, and therefore, it took a lot of time to complete the cartoon. Meanwhile, with the recent development of the computer technology, many writers use an electronic device such as a computer to produce the cartoon. For example, it is possible to draw the sketch of the cartoon using an input device, or to paint the sketch using the input device. However, since this process also requires the writer's intervention, there is a problem in that it takes a considerable amount of time.

### SUMMARY OF INVENTION

### Technical Problem

An object of the present disclosure is to provide a device and a method capable of determining a reference painted image suitable for coloring a sketch image among previously painted images.

Another object of the present disclosure is to provide a device and a method capable of coloring a sketch image using the determined reference painted image.

### Solution to Problem

A device according to exemplary embodiments of the present disclosure includes: a communicating circuit configured to receive a sketch image of a cartoon from a user terminal, a memory configured to store the sketch image and painted images, and a processor configured to, by executing a program stored in the memory, determine a reference painted image to be referred for coloring the sketch image among the stored painted images, in which the processor determines the reference painted image based on similarity between the painted image and each of the painted images.

A method performed by a computing device according to the exemplary embodiments of the present disclosure includes: receiving a sketch image of a cartoon, storing the sketch image and painted images, and determining a reference painted image to be referred for paining the sketch image among the stored painted images based on a similarity between the painted image and each of the painted images.

### Advantageous Effects of Invention

The method according to the exemplary embodiments of the present disclosure can be implemented in the form of a program executed by the computing device, and the program can be stored in a computer readable non-temporary storage medium.

According to the exemplary embodiments of the present disclosure, the device can receive the sketch image, determine the reference painted image to be used for coloring the sketch image among the stored painted images, provide the determined reference painted image to the user, or paint the sketch image using the reference painted image. Therefore, the time required for coloring the sketch image can be reduced, thereby reducing the time required for completing the cartoon.

### BRIEF DESCRIPTION OF DRAWINGS

FIG. 1 shows a coloring system according to exemplary embodiments of the present disclosure.

FIG. 2 shows a control unit according to the exemplary embodiments of the present disclosure.

FIG. 3 is a diagram for explaining an operation of a device according to the exemplary embodiments of the present disclosure.

FIG. 4 is a flowchart showing a method for operating the device according to the exemplary embodiments of the present disclosure.

FIGS. 5 to 8 are diagrams for explaining determining a reference painted image according to the exemplary embodiments of the present disclosure.

FIG. 9 is a flowchart showing a method for coloring a sketch image according to the exemplary embodiments of the present disclosure.

FIGS. 10 to 12 show a method for coloring the sketch image according to the exemplary embodiments of the present disclosure.

### DESCRIPTION OF EMBODIMENTS

To clearly explain the present disclosure, portions irrelevant to the description are omitted, and the same or similar components are denoted by the same reference numerals throughout the specification.

Although not defined otherwise, all terms including technical terms and scientific terms used herein have the same meaning as those commonly understood by those skilled in the art to which the present disclosure pertains. Terms defined in the dictionary commonly used are additionally interpreted as having a meaning consistent with the related technical literature and the currently disclosed content, and are not interpreted as an ideal or very formal meaning unless defined.

Hereinafter, exemplary embodiments of the present disclosure will be described in detail with reference to the accompanying drawings so that those skilled in the art to which the present disclosure pertains can easily carry out them. However, the present disclosure can be implemented in various different forms and is not limited to the exemplary embodiments described herein.

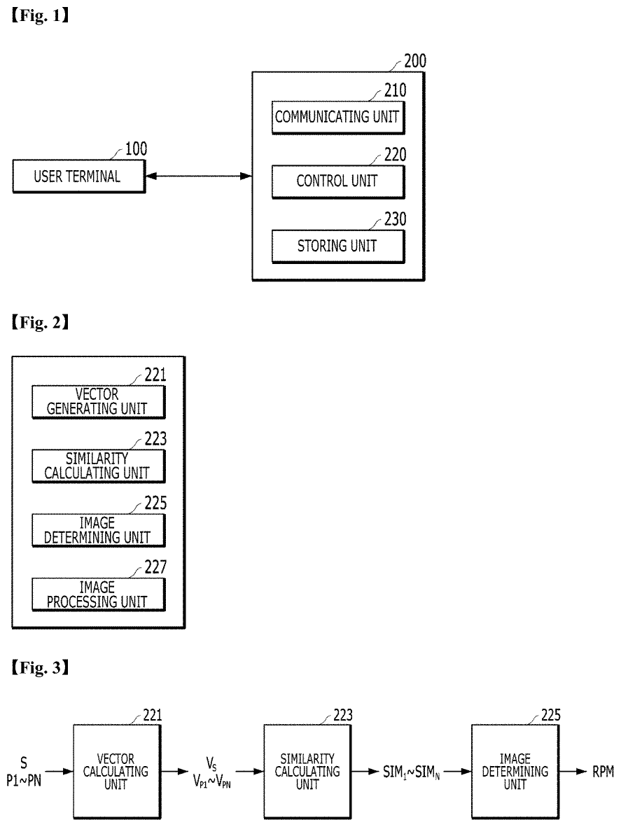

FIG. 1 shows a coloring system according to exemplary embodiments of the present disclosure. A coloring system can include a user terminal 100 and a device 200.

The user terminal 100 can transmit a sketch image to be painted according to a user's operation to the device 200. For example, the sketch image can include an outline indicating objects (e.g., appearance characters and surrounding objects) in a cartoon. The sketch image can also be referred to as a line art image.

According to exemplary embodiments, the user terminal 100 can generate or store a sketch image to be painted. For example, the sketch image can be an image in which coloring (or painting) is not completed. In other words, the sketch image can be an image including an unpainted portion.

The user terminal 100 can receive a reference painted image to be referred for painting from the device 200, or receive a painted sketch image based on the reference painted image. According to the exemplary embodiments, the user terminal 100 can also paint the unpainted sketch image using the reference painted image transmitted from the device 200.

The user terminal 100 is a computing device having an arithmetic processing function, and can be a mobile device or a fixed device. For example, the user terminal 100 can mean a computer, a personal computer (PC), a smart phone, a navigation, a laptop computer, a tablet computer, a wearable device, or a tablet, but the exemplary embodiments of the present disclosure are not limited thereto.

The user terminal 100 can communicate with the device 200 using a communication method. According to the exemplary embodiments, the user terminal 100 can exchange image data with the device 200 according to a wireless communication method or a wired communication method.

For example, the wireless communication method can include a wireless LAN (WLAN), a wireless broadband (Wibro), a wideband CDMA (WCDMA), IEEE 802.16, a long term evolution (LTE), a long term evolution-advanced (LTE-A), Bluetooth, a radio frequency identification (RFID), an infrared communication (infrared data association: IrDA), an ultra-wideband (UWB), ZigBee, a near field communication (NFC), an ultra sound communication (USC), a visible light communication (VLC), a Wi-Fi, etc., but is not limited thereto.

For example, the wired communication protocol can include a wired local area network (LAN), wired wide area network (WAN), a power line communication (PLC), an USB communication, an Ethernet, a serial communication, an optical/coaxial cable communication, but is not limited thereto.

The device 200 can store a painted image. The painted image can be an image constituting a cartoon. For example, the painted image can include outlines and colors representing objects (e.g., characters and surrounding objects) in the cartoon.

According to the exemplary embodiments, the device 200 can extract (or collect) the painted image from the cartoon. For example, the device 200 can extract (or collect) the painted image from the posted cartoon using the address of a web page on a web on which the cartoon is posted, but is not limited thereto.

According to the exemplary embodiments, the device 200 can store the painted image and order information of the painted image together. At this time, the order information can represent an order in the cartoon of each of the painted images. For example, the order information can mean information about an episode of the cartoon including the painted image or a cut including the painted image.

The device 200 can receive a sketch image to be painted from the user terminal 100 and determine a reference painted image to be used for painting the sketch image among previously stored painted images. At this time, the reference painted image can be an image similar to the sketch image.

The device 200 can transmit the determined reference painted image to the user terminal 100 or paint the sketch image using the reference painted image. For example, the device 200 can paint each of the objects included in the sketch image with the color of a similar object included in the reference painted image.

The device 200 can be a computing device having an arithmetic processing function. For example, the device 200 can be a server computer capable of communicating with the user terminal 100, but is not limited thereto.

The device 200 can include a communicating unit 210, a control unit 220, and a storing unit 230.

The communicating unit 210 can exchange data with the user terminal 100. According to the exemplary embodiments, the communicating unit 210 can exchange image data with the device 200 according to the wireless communication method or the wired communication method.

The control unit 220 can control overall operations of the device 200. According to the exemplary embodiments, the control unit 220 can determine the reference painted image to be used for painting the sketch image among the previously stored painted images.

In other words, the control unit 220 can mean a device capable of performing a series of operations or determinations for operating the device 200. For example, the control unit 220 can be a central processing unit (CPU), a micro controller unit (MCU), a graphic processing unit (GPU), an application specific integrated circuit (ASIC), or a field programmable gate array (FPGA), but is limited thereto.

The storing unit 230 can store data necessary for operating the device 200. According to the exemplary embodiments, the storing unit 230 can store the sketch image to be painted and the painted image for reference when coloring or painting the sketch image.

In addition, the storing unit 230 can store a program composed of instructions for performing a series of operations performed by the device 200.

The storing unit 230 can include a non-volatile memory device or a volatile memory device. According to the exemplary embodiments, the storing unit 230 can be configured to be included in the control unit 220, but is not limited thereto.

FIG. 2 shows a control unit according to the exemplary embodiments of the present disclosure. Referring to FIG. 2, the control unit 220 can include a vector calculating unit 221, a similarity calculating unit 223, an image determining unit 225, and an image processing unit 227.

Each of the components 221, 223, 225, and 227 of the control unit 220 shown in FIG. 2 can be physically separated hardware. At this time, at least two components 221, 223, 225, and 227 can also be integrally implemented. In addition, each of the components 221, 223, 225, and 227 can also be a functionally distinct module. That is, each of the components 221, 223, 225, and 227 can mean a functional block performing each function of the control unit 220, and at this time, each of the components 221, 223, 225, and 227 can be implemented in at least one processor. In other words, operations or functions of components 221, 223, 225 and 227 can be performed by at least one processor which execute a program including instructions.

The vector calculating unit 221 can generate (or calculate) a vector representing the image from the image. According to the exemplary embodiments, the vector calculating unit 221 can calculate vectors representing the sketch image and each of the painted images from the stored sketch image and each of the painted images.

According to the exemplary embodiments, the vector calculating unit 221 can generate a vector representing a feature of the image. In other words, the generated vector can have a value representing the shape, form, and appearance of the image. Since the direction of the vector is determined by the value of the vector, as a result, two images representing similar shapes, forms, appearances, etc. can have two vectors having similar directions. As described above, generating (or calculating) the vector representing the image from the image can be referred to as an image embedding. At this time, the vector can be an element of a multidimensional space.

According to the exemplary embodiments, the vector calculating unit 221 can calculate the vector representing the image from the image based on a Deep Learning algorithm. For example, the Deep Learning algorithm can be an algorithm generated through learning that allows vectors for the images having similar characteristics (shape, form, appearance, etc.) to have similar directions using the previously prepared learning images as a learning data set.

The similarity calculating unit 223 can calculate the similarity between the images using the vectors for the images generated by the vector calculating unit 221. According to the exemplary embodiments, the similarity calculating unit 223 can calculate a similarity between the sketch image and the painted image. For example, the similarity calculating unit 223 can calculate the similarity between the sketch image and the painted image based on the vector associated with the sketch image and the vector associated with the painted image.

The similarity is a value representing a similar degree of the characteristics (shape, form, appearance, etc.) of two images, and can be a value representing a similar degree of the sketches included in the two images according to the exemplary embodiments.

The similarity calculating unit 223 can calculate the similarity based on the directions of the two vectors. According to the exemplary embodiments, the similarity calculating unit 223 can calculate the similarity between the two images as a high value as the directions of the two vectors representing each of the two images are similar. For example, the similarity calculating unit 223 can calculate the similarity between the images by calculating a cosine similarity between the vectors representing the images, but the exemplary embodiments of the present disclosure are not limited thereto.

The image determining unit 225 can determine the reference painted image to be used (or suitable to be used) for coloring or painting the sketch image among the painted images.

The image determining unit 225 can determine a similar painted image similar to the sketch image among the painted images based on the similarity calculated by the similarity calculating unit 223. For example, the similar painted image is an image including a character identical to the character included in the sketch image, an image including an object that is the same as or similar to the object included in the sketch image, or an image including a boundary having a shape that is the same as or similar to a boundary included in the sketch image.

According to the exemplary embodiments, the image determining unit 225 can compare the similarity between the stored painted image and the sketch image with a reference value, and determine the painted image having a similarity equal to or larger than the reference value among the painted images according to the comparison result as the similar painted image. At this time, there can be one or one or more similar painted image.

In addition, the image determining unit 225 can determine the reference painted image among the similar painted images. According to the exemplary embodiments, the image determining unit 225 can determine the reference painted image among the similar painted images based on order information of each of the painted similar images.

The image determining unit 225 can determine a similar painted image included in a relatively recent episode or recent cut among the similar painted images as the reference painted image. For example, the image determining unit 225 can determine a similar painted image included in an episode (or cut) within the reference order as the reference painted image.

Also, the device 200 can preferentially determine the similar painted image included in a relatively more recent episode (or cut) as the reference painted image. In other words, if there are a plurality of reference painted images, the device 200 can set the priority of the reference painted images according to the order information of the reference painted images. For example, the device 200 can set the priority of a reference painted image included in the latest episode (or cut) as the highest priority.

The image processing unit 227 can transmit the determined reference painted image to the user terminal 100. Alternatively, the image processing unit 227 can also visually display the determined reference painted image to the user. For example, when there are a plurality of reference painted images, the image processing unit 227 can sequentially display the reference painted images according to the priority.

The image processing unit 227 can paint the sketch image using the determined reference painted image. For example, when there are a plurality of reference painted images, the image processing unit 227 can paint the sketch image using the reference painted image selected by the user or the reference painted image having the highest priority.

According to the exemplary embodiments, the image processing unit 227 can paint the sketch image using colors corresponding to the colors included in the determined reference painted image. For example, the image processing unit 227 can paint a color of an area (e.g., an area formed in a closed curve) of the sketch image using a color of a corresponding area of the reference painted image. For example, the image processing unit 227 can paint the sketch image by setting the color coordinates of each of pixels in the area of the sketch image as the same value as the color coordinates of the corresponding pixels in the area of the reference painted image.

According to the exemplary embodiments of the present disclosure, the device 200 can receive the sketch image, determine the reference painted image to be used for painting the sketch image among the stored painted images, and provide the determined reference painted image to the user, or paint the sketch image using the reference painted image. Accordingly, the time required for painting the sketch image can be reduced, thereby reducing the time required for completing the cartoon.

FIG. 3 is a diagram for explaining an operation of a device according to the exemplary embodiments of the present disclosure. Referring to FIG. 3, the device 200 can store a sketch image (S) and a painted image P1 to PN; N is a natural number equal to or greater than 1).

The vector calculating unit 221 can calculate a vector (Vs) associated with the sketch image (S) from the sketch image (S). In addition, the vector calculating unit 221 can calculate vectors (V_{P1} to V_{PN}) associated with the painted images (P1 to PN) from the painted images (P1 to PN). The vectors (Vs and V_{P1} to V_{PN}) can be variables representing the characteristics of the sketch image and each of the painted images.

The similarity calculating unit 223 can calculate the similarity between the sketch image and the painted image using the vectors (Vs and V_{P1} to V_{PN}) for the images generated by the vector calculating unit 221. For example, the similarity calculating unit 223 can calculate similarities (SIM₁ to SIM_{N}) of the sketch image (S) and each of the painted images (P1 to PN).

The image determining unit 225 can determine a reference painted image (RPM) among the painted images (P1 to PN). According to the exemplary embodiments, the image determining unit 225 can determine a similar painted image similar to the sketch image (SI) among the painted images (P1 to PN) based on the similarities (SIM₁ to SIM_{N}) calculated by the similarity calculating unit 223. At this time, there can be one or one or more similar painted image.

In addition, the image determining unit 225 can determine the reference painted image among the similar painted images. According to the exemplary embodiments, the image determining unit 225 can determine the reference painted image (RPM) to be used for painting the sketch image (SI) among the similar painted images.

FIG. 4 is a flowchart showing a method for operating the device according to the exemplary embodiments of the present disclosure. Referring to FIG. 4, the device 200 can receive the painted image (S110). According to the exemplary embodiments, the device 200 can extract (or obtain) the painted image from the cartoon. At this time, the device 200 can store the received painted image. According to the exemplary embodiments, the device 200 can store the painted image and the order information of the painted image together.

The device 200 can receive the sketch image (S120). According to the exemplary embodiments, the device 200 can receive the sketch image from the user terminal 100 and store the received sketch image. For example, the sketch image can be an image generated according to the operation of the input device interlocked with the user terminal 100 and stored in the user terminal 100.

The device 200 can select the similar painted images similar to the sketch image among the stored painted images (S130). The similar painted image can be an image having a shape similar to that of the sketch image. For example, the similar painted image is an image including a character identical to the character included in the sketch image, an image including an object that is the same as or similar to the object included in the sketch image, or an image including a boundary having a shape that is the same as or similar to a boundary included in the sketch image.

According to the exemplary embodiments, the device 200 can calculate the vectors associated with the sketch image and each of the painted images and calculate the similarity between the sketch image and each of the painted images using the calculated vectors. The device 200 can select the similar painted image based on the calculated similarity.

The device 200 can determine the reference painted image to be referred for painting the sketch image among the similar painted images (S140). According to the exemplary embodiments, the device 200 can determine the reference painted image among the similar painted images. For example, the device 200 can determine the reference painted image among the similar painted images based on the order information of the similar painted images.

The device 200 can provide the determined reference painted image to the user (S150). According to the exemplary embodiments, the device 200 can visually display the reference painted image or transmit the reference painted image to the user terminal 100.

The device 200 can paint the sketch image using the determined reference painted image (S160). According to the exemplary embodiments, the device 200 can generate a final image by painting the sketch image using the color included in the determined reference painted image.

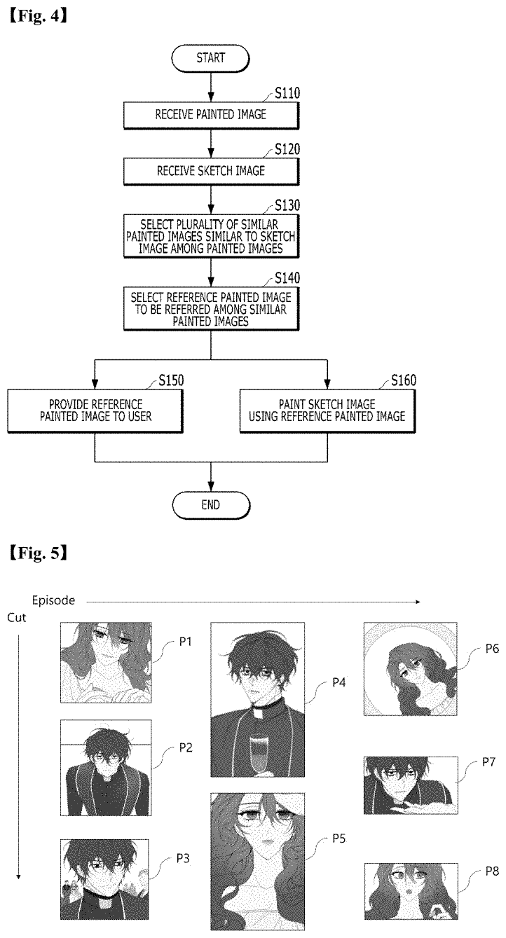

FIGS. 5 to 8 are diagrams for explaining determining a reference painted image according to the exemplary embodiments of the present disclosure.

Referring to FIG. 5, the device 200 can store painted images (P1 to P8). As described above, the painted images (P1 to P8) can be images constituting a cartoon. As shown in FIG. 5, each of the painted images (P1 to P8) can be an image corresponding to a specific episode and a specific cut of the cartoon.

For example, a first painted image (P1) can be an image of a first cut of a first episode, a second painted image (P2) can be an image of a second cut of the first episode, and a third painted image (P3) can be an image of a third cut of the first episode. In addition, for example, a fourth painted image (P4) can be an image of a first cut of a second episode, and a fifth painted image (P5) can be an image of a second cut of the second episode. In addition, for example, a sixth painted image (P6) can be an image of a first cut of a third episode, a seventh painted image (P7) can be an image of a second cut of the third episode, and an eighth painted image (P8) can be an image of a third cut of the third episode.

Referring to FIG. 6, the device 200 can store the painted images (P1 to P8) and the order information of the painted images (P1 to P8) together. The order information of the painted images (P1 to P8) can mean information on the episode of the cartoon including the painted image or the cut including the painted image. For example, the order information of the first painted image (P1) can be information representing that the first painted image (P1) corresponds to the image of the first cut of the first episode.

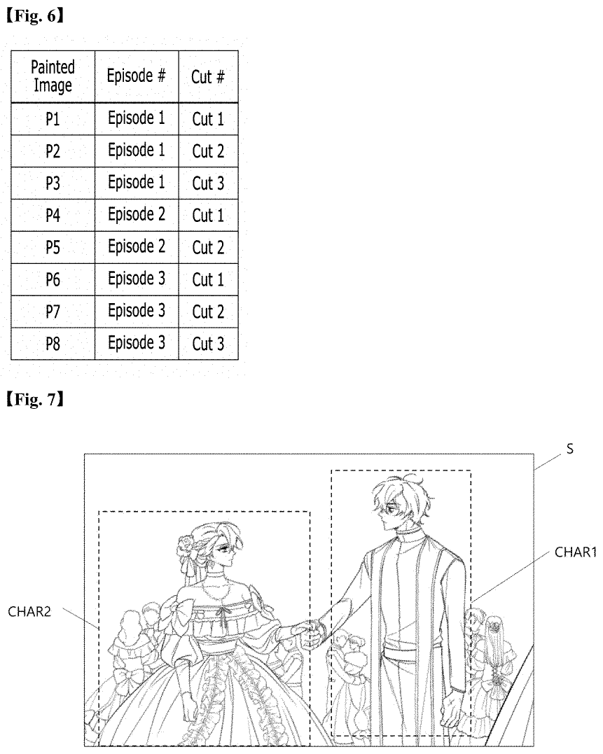

Referring to FIG. 7, the device 200 can store the sketch image (S). According to the exemplary embodiments, the device 200 can receive the sketch image (S) from the user terminal 100.

The sketch image (S) can represent a plurality of characters (or objects). For example, the sketch image (S) can represent characters (CHAR1, CHAR2). The device 200 can process the sketch image (S) and recognize the characters (CHAR1, CHAR2) of the sketch image (S) according to the processed result. For example, the device 200 can calculate information (e.g., coordinates) for distinguishing and recognizing the characters (CHAR1, CHAR2) expressed in the sketch image (S) and identifying the characters (CHAR1, CHAR2) according to an image processing algorithm. In addition, the device 200 can recognize the characters (CHAR1, CHAR2) expressed in the sketch image (S) and crop the sketch image (S) to an area including each of the recognized characters (CHAR1, CHAR2), but is not limited thereto.

The device 200 can recognize the characters (CHAR1, CHAR2) included in the sketch image (S), and therefore, determine the reference painted image to be used for painting each of the characters (CHAR1, CHAR2) included in the sketch image (S).

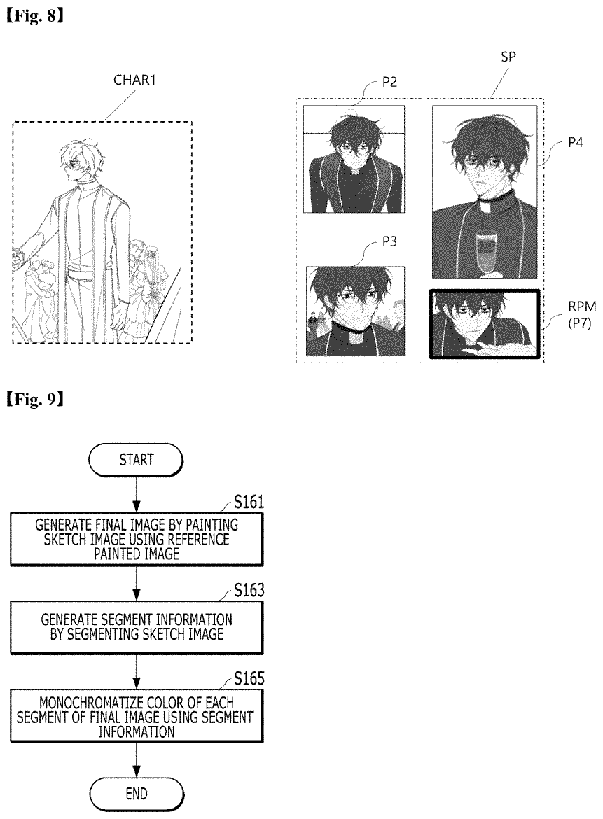

Referring to FIG. 8, the device 200 can determine the reference painted image to be referred for painting the sketch image (S) among the painted images (P1 to P8). According to the exemplary embodiments, the device 200 can select a similar painted image (SP) similar to the sketch image (S) among the painted images (P1 to P8) and determine the reference painted image (RPM) among the similar painted images.

For example, the device 200 can select the similar painted image (SP) similar to the first character (CHAR1) of the sketch image (S) among the painted images (P1 to P8). For example, the device 200 can select the second painted image (P2), the third painted image (P3), the fourth painted image (P4), and the seventh painted image (P7) in which a character similar to the first character (CHAR1) appears as the similar painted image (SP).

In addition, for example, the device 200 can determine the reference painted image (RPM) among the similar painted images (P2, P3, P4, and P7) based on the order information of the similar painted images (P2, P3, P4, and P7). At this time, the device 200 can determine, as the reference painted image (RPM), the similar painted image included in the latest episode or the latest cut among the similar painted images (P2, P3, P4, and P7).

Referring to FIGS. 5 to 8, since the seventh painted image (P7) is the second cut of the third episode, and the similar painted image included in the latest episode or the latest cut among the similar painted images (P2, P3, P4, and P7), the device 200 can determine the seventh painted image (P7) as the reference painted image (RPM).

According to the exemplary embodiments of the present disclosure, the device 200 can receive the sketch image (S) and determine, as the reference painted image (RPM), the latest painted image most similar to the sketch image (S) among the stored painted images (P1 to P8).

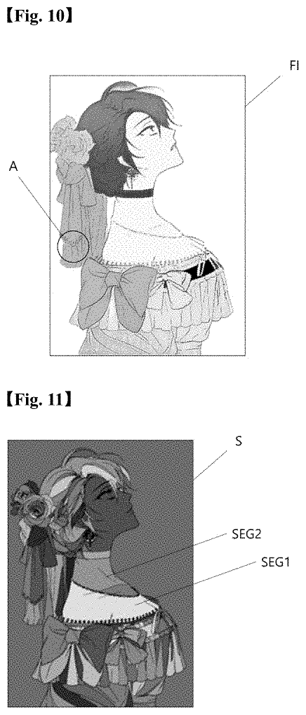

FIG. 9 is a flowchart showing a method for painting a sketch image according to the exemplary embodiments of the present disclosure. Operations described with reference to FIG. 9 can be performed by the device 200 or the image processing unit 227.

Referring to FIG. 9, the device 200 can paint the sketch image using the determined reference painted image, and generate a final image according to the painted result (S161). According to the exemplary embodiments, the device 200 can paint the color of the area (e.g., the area formed in the closed curve) of the sketch image using the color of the corresponding area of the reference painted image.

The device 200 can segment the (unpainted) sketch image to generate segment information (S163). According to the exemplary embodiments, the device 200 can divide (i.e., segment) the sketch image into a plurality of areas each having the closed curve and generate segment information on each of the divided areas. At this time, the segment information can be information for identifying each of the divided areas. For example, the segment information can include coordinate information of each of the divided areas, but is not limited thereto.

The device 200 can monochromaticize the color of each segment of the final image using the segment information generated from the sketch image (S165). According to the exemplary embodiments, since the final image is the one that paints the sketch image, the sketch (i.e., outline) is the same. Therefore, the segmentation of the final image is possible by using the segment information of the sketch image. In addition, segmenting the final image using the segment information of the sketch image in which only the outline exists without painting has a much more accurate effect than segmenting the final image itself.

Therefore, the device 200 can recognize each segment of the final image by segmenting the final image using the segment information generated from the sketch image, and paint each recognized segment with a single color (one color). For example, the device 200 can set the color coordinates of the pixels in a specific segment of the final image as one value.

According to the exemplary embodiments, the device 200 can change the color coordinates of the pixels included in each of the segments included in the final image to representative values representing the color coordinate values of the pixels. At this time, the representative value can be an average value, a maximum value, a mode, or a minimum value, but is not limited thereto.

According to the exemplary embodiments, the apparatus 200 can set the color of each of the segments included in the final image as any one of the reference colors. At this time, the reference color can be a color previously set by the user, but is not limited thereto. For example, the device 200 can set the color of each of the segments included in the final image as the reference color most similar to the existing color of each of the segments among the reference colors. For example, the device 200 can select the reference color most similar to the color coordinates (or the average value, mode, maximum value of the color coordinates) of the pixels in each of the segments among the reference colors, and set the color coordinates of the pixels in the corresponding segment as the selected similar reference color.

Therefore, it is possible to prevent the color of the final image from blurring, and to express colors suitable for the cartoon.

FIGS. 10 to 12 show a method for painting the sketch image according to the exemplary embodiments of the present disclosure.

FIG. 10 shows a final image (FI) generated by painting the sketch image using the reference painted image. According to the exemplary embodiments, the device 200 can paint the color of the area (e.g., the area formed in the closed curve) of the sketch image using the color of the corresponding area of the reference painted image. At this time, as shown in FIG. 10, a portion in which the color blurs can appear in the final image (FI) (e.g., portion A) according to the form of the reference painted image.

Referring to FIG. 11, the device 200 can segment the sketch image to generate the segment information and segment the final image (FI) using the segment information. According to the exemplary embodiments, the device 200 can segment the final image (FI) to divide the final image into a plurality of segments including the segments (SEG1, SEG2). Each of the segments (e.g., SEG1, SEG2) can mean an area formed in a closed curve.

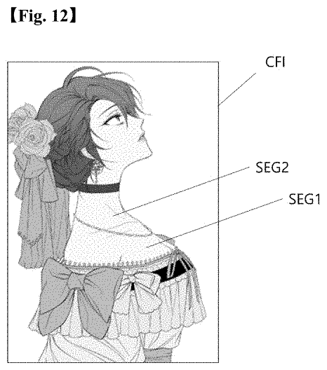

Referring to FIG. 12, the device 200 can generate a corrected final image (CFI) by painting the segments (e.g., SEG1, SEG2) of the final image (FI) with a single color (one color). For example, the device 200 can set the color coordinates of the pixels in each segment of the final image (FI) as one value.

According to the exemplary embodiments, the device 200 can set the color coordinates of the pixels in each segment of the final image (FI) as the representative values representing the color coordinate values of the pixels in each segment. In addition, the device 200 can set the color of each of the segments included in the final image (FI) to any one of predetermined reference colors.

According to the monochromaticizing process according to the exemplary embodiments of the present disclosure, it is possible to prevent the color appearing in the final image (FI) from blurring (e.g., portion A in FIG. 10), and to express colors suitable for the cartoon.

While the preferred exemplary embodiments according to the present disclosure have been described above, they can be modified in various forms, and it is understood that those skilled in the art can carry out various changes and modifications without departing from the scope of the present disclosure.

1. A device comprising:
a communicating circuit configured to receive a sketch image of a cartoon from a user terminal;
a memory configured to store the sketch image and painted images; and
a processor configured to, by executing a program stored in the memory, determine a reference painted image to be referred for painting the sketch image among the stored painted images,
wherein the processor determines the reference painted image based on similarity between the painted image and each of the painted images.

2. The device of claim 1,
wherein the processor:
calculates vectors representing characteristics of each of the sketch image and the painted images from the sketch image and each of the painted images,
calculates the similarity between the sketch image and each of the painted images using the vectors, and
determines the reference painted image among the painted images based on the similarity.

3. The device of claim 2,
wherein the processor calculates the similarity based on directions of the vector of the sketch image and the vectors of each of the painted images.

4. The device of claim 2,
wherein the processor compares the similarity between the sketch image and each of the painted images and a reference value and determines, as the reference painted image, a painted image similar to the sketch image among the painted images according to the comparison result.

5. The device of claim 4,
wherein the memory stores the painted images and order information representing an order in a cartoon of each of the painted images, and
wherein the processor selects similar painted images similar to the sketch image among the painted images based on the similarity, and determines the reference painted image among the similar painted images based on order information of each of the similar painted images.

6. The device of claim 5,
wherein the order information comprises: information on an episode or cut of the cartoon comprising the painted images.

7. The device of claim 2,
wherein the processor generates a final image by painting the sketch image using the determined reference painted image.

8. The device of claim 7,
wherein the processor divides the sketch image into a plurality of segments, and generates segment information comprising information for identifying each of the divided segments, and divides the final image into a plurality of segments using the segment information for the sketch image, and monochromaticizes a color of each of the plurality of segments of the final image.

9. A method performed by a computing device, the method comprising:
receiving a sketch image of a cartoon;
storing the sketch image and painted images; and
determining a reference painted image to be referred for paining the sketch image among the stored painted images based on a similarity between the painted image and each of the painted images.

10. The method of claim 9,
wherein the determining of the reference painted image comprises:
calculating vectors representing the sketch image and characteristics of each of the painted images from the sketch image and each of the painted images;
calculating the similarity between the sketch image and each of the painted images using the vectors; and
determining the reference painted image among the painted images based on the similarity.

11. The method of claim 9,
wherein the determining of the reference painted image further comprises:
comparing the similarity between the sketch image and each of the painted images with a reference value and determining, as the reference painted image, a painted image similar to the sketch image among the painted images according to the comparison result.

12. The method of claim 9,
wherein the method further comprises: storing the painted images and order information representing an order in a cartoon of each of the painted images, and
wherein the determining of the reference painted image further comprises:
selecting similar painted images similar to the sketch image among the painted images based on the similarity; and
determining the reference painted image among the similar painted images based on order information of each of the similar painted images.

13. The method of claim 9,
wherein the method further comprises:
generating a final image by painting the sketch image using the determined reference painted image;
dividing the sketch image into a plurality of segments and generating segment information comprising information for identifying each of the divided segments;
dividing the final image into a plurality of segments using the segment information for the sketch image; and
monochromaticizing a color of each of the plurality of segments of the final image.

14. A computer readable non-temporary storage medium configured to perform the method of claim 9 and configured to store a program executed by a computing device.
